(19) United States
(12) Patent Application Publication
(10) Pub. No.: US 2017/0144871 A1
(43) Pub. Date: May 25, 2017

(54) APPARATUS FOR OPERATING HAND CHAIN HOIST

(71) Applicant: STEWART ENGINEERING & SALES CO., MUSKEGON, MI (US)

(72) Inventor: Kenneth J. Stewart, Muskegon, MI (US)

(73) Assignee: STEWART ENGINEERING & SALES CO., MUSKEGON, MI (US)

(21) Appl. No.: 15/427,683

(22) Filed: Feb. 8, 2017

Related U.S. Application Data
(63) Continuation-in-part of application No. 15/236,954, filed on Aug. 15, 2016.
(60) Provisional application No. 62/206,526, filed on Aug. 18, 2015.

(51) Int. Cl. B66D 1/12; B66D 1/22

(52) U.S. Cl. CPC B66D 1/12; B66D 1/22; B66D 2700/025

(57) ABSTRACT

An apparatus for operating a hand chain of a hand chain hoist. A housing forms a void through which a hand chain of the hand chain hoist moves in either a lifting direction or a lowering direction, to lift or lower, respectively, a load corresponding to the hand chain hoist. A sprocket or two pulleys are movably mounted within the housing. A drive, such as a right angle drill, operably moves the sprocket and/or the pulley and thus moves the hand chain, selectively, in the lifting direction or the lowering direction. A line, a cord and/or another suitable structural element connects the housing to an overhead structure. Another line, cord and/or other suitable structural element connects or holds the housing with respect to a ground surface or another fixed structural element, and an operator can use this line, which can be adjustable, to tighten and hold the overall chain hoist drive time of this invention.

### CROSS REFERENCE TO RELATED APPLICATIONS

This Patent Application claims the benefit of both U.S. Provisional Patent Application having Ser. No. 62/206,526, filed on 18 Aug. 2015, and U.S. Patent Application having Ser. No. 15/236,954, filed on 15 Aug. 2016, and this co-pending U.S. Provisional Patent Application and co-pending U.S. Patent Application are incorporated by reference herein in their entirety and each is made a part of this specification and of this Patent Application, including but not limited to those portions which specifically appear in this Patent Application.

### BACKGROUND OF THE INVENTION

Field of the Invention

This invention relates to an apparatus or a drive that can be used to operate a hand chain hoist, for example, one that is powered with a right angle drive and that is used by an operator to eliminate the labor required to pull on the hand chain.

Discussion of Related Art

Hand chain drives are used primarily to operate hand chain hoists, and also large overhead doors and valves.

Conventional hand chain hoists have been used for many years to lift workpieces and other loads. Some powered portable devices are known to operate manual chain hoists. For example, U.S. Pat. Nos. 5,678,452, 6,179,270 and 6,820,863 disclose portable powered drivers for operating chain hoists, and the entire disclosures of each and every one of U.S. Pat. Nos. 5,678,452, 6,179,270 and 6,820,863 are incorporated into this specification by reference thereto.

Conventional drills and other drives or drivers have been used to supply a rotating shaft to a workpiece. For example, conventional drills have a rotating head or chuck piece that can be attached to a drill bit or a grinder wheel to rotate a workpiece.

There is an apparent need for a device that can be easily attached to an existing hand chain of a hand chain hoist, including a device that uses relatively inexpensive O-rings within at least two pulleys or a pulley system to power operate the hand chain in a lifting direction or a lowering direction.

### SUMMARY OF THE INVENTION

A hand chain drive and/or another suitable apparatus according to this invention can power operate any standard hand chain operated device such as a hoist, a door or a valve. The chain drive of this invention accepts a lifting section of a hand chain from a hand chain hoist, for lifting a load, is operated to lift the load, and then returns the lifting section of the chain to the conventional hand chain hoist which is located overhead or above the chain hoist drive of this invention. The chain drive of this invention is moved to the lowering section of the chain from the hand chain hoist, for lowering the load, and then returning the lowering section of the chain to the conventional hand chain hoist.

According to some embodiments of this invention, an upper section of a line is attached to an overhead structure, such as a hoist or a trolley, and an opposite lower section of the line is attached to a support frame or structure to which a right angle drive can be mounted. Using the line and support frame balances and eliminates the weight and resulting torsional loads that an operator experiences while operating the chain hoist drive of this invention. For example, the operator can use one hand to hold onto and guide the support frame and use the other hand to operate the drive.

In some embodiments of this invention, the operator can lift a load in a first direction and then move the hand chain of this invention to lower the load in a second direction which is opposite or different with respect to the first direction. In some embodiments of this invention, the drive sprocket or pulleys can be universally designed to accommodate different hand chain sizes as supplied by various hoist manufacturers.

According to some embodiments of this invention, at least two rotatable pulleys are each mounted within a housing and rotatably engage the hand chain moving through the housing. The two pulleys or the pulley system or arrangement can use relatively inexpensive parts, particularly when compared to the drive sprocket, including inexpensive O-rings which can be easily replaced when worn or spent. It also requires significantly less labor time to remove and replace a worn O-ring, particularly compared to replacing the drive sprocket. Also, with the drive sprocket it is necessary to remove the drive sprocket and replace it with a differently sized drive sprocket in order to accommodate a differently sized chain but with the pulley system or arrangement and particularly the O-rings it is not necessary to change the pulleys and/or the O-rings to accommodate differently sized chains.

In some embodiments of this invention, the two pulleys or the pulley system arrangement operates quieter with less noise and smoother, particularly when compared to the sprocket wheel. In some embodiments of this invention, the pulley system or arrangement increases the capacity of the overall system, for example, by allowing the chain to move faster through the apparatus for operating the hand chain. In some embodiments of this invention, the overall cost of the apparatus for operating a hand chain is also significantly reduced by using the pulley system or pulleys arrangement, particularly when using the O-rings.

### BRIEF DESCRIPTION OF THE DRAWINGS

The features of different embodiments of this invention can be better understood when described in view of the drawings, wherein:

FIG. 1 shows a front view of a chain hoist drive with a hand chain, according to one embodiment of this invention;

FIG. 2 shows a side view of the chain hoist drive, as shown in FIG. 1 but without a hand chain;

FIG. 3 shows a front view of a drive, such as a right angle drill and/or a right angle drive, according to one embodiment of this invention;

FIG. 4 shows a side view of the drive, as shown in FIG. 3;

FIG. 5 shows a side view of a support frame, according to one embodiment of this invention;

FIG. 6 shows a front view of the support frame, as shown in FIG. 5;

FIG. 7 shows a broken top view of the support frame, as shown in FIGS. 5 and 6;

FIG. 8 shows a side view of a sprocket, according to one embodiment of this invention;

FIG. 9 shows a front view of the sprocket, as shown in FIG. 8;

FIG. 10 shows a top view of the sprocket, as shown in FIG. 8;

FIG. 11 shows a view of the sprocket, taken along line 11-11 as shown in FIG. 9;

FIG. 12 shows a front view of a chain, such as a hand chain, according to one embodiment of this invention;

FIG. 13 shows a front view of a housing, according to one embodiment of this invention;

FIG. 14 shows a sectional view of the housing, taken along line 14-14 as shown FIG. 13;

FIG. 15 shows a rear view of the housing, as shown in FIG. 13;

FIG. 16 shows a top view of the housing, as shown in FIG. 13;

FIG. 17 shows a partial front view of a fastener, according to one embodiment of this invention;

FIG. 18 shows a front view of an element for the housing, according to one embodiment of this invention;

FIG. 19 shows a partial side view of a handle and an anchor, according to one embodiment of this invention;

FIG. 20 shows a partial front view of the handle and the anchor, as shown in FIG. 19;

FIG. 21 shows a front view of an anchor, according to one embodiment of this invention;

FIG. 22 shows a side view of the anchor, as shown in FIG. 21;

FIG. 23 shows a side view, opposite the side view shown in FIG. 22, of the anchor, as shown FIG. 21;

FIG. 24 shows a front view of a chain hoist drive with a hand chain, according to one embodiment of this invention;

FIG. 25 shows a front view of an apparatus for operating a hand chain, according to one embodiment of this invention;

FIG. 26 shows a side view of the apparatus, as shown in FIG. 25;

FIG. 27 shows a front view of a drive, such as a right angle drill and/or a right angle drive, according to one embodiment of this invention;

FIG. 28 shows a side view of the drive, as shown in FIG. 27;

FIG. 29 shows a front view of a pulley, according to one embodiment of this invention;

FIG. 30 shows a partial cross-sectional view of the pulley, as shown in FIG. 29;

FIG. 31 shows a side view of a disc, according to one embodiment of this invention;

FIG. 32 shows a front view of the disc, as shown in FIG. 31;

FIG. 33 shows a side view of a gear, according to another embodiment of this invention;

FIG. 34 shows a front view of the gear, as shown in FIG. 33;

FIG. 35 shows a side view of a hub or a hub assembly, according to one embodiment of this invention;

FIG. 36 shows a front view of the hub or the hub assembly, as shown in FIG. 35;

FIG. 37 shows a front view of a housing, according to one embodiment of this invention;

FIG. 38 shows a sectional view of the housing taken along line 38-38, as shown in FIG. 37;

FIG. 39 shows a bottom view of the housing, as shown in FIG. 37;

FIG. 40 shows a top view of the housing, as shown in FIG. 37;

FIG. 41 shows a rear view of a housing, according to one embodiment of this invention;

FIG. 42 shows a sectional view of the housing taken along line 42-42, as shown in FIG. 41;

FIG. 43 shows a bottom view of the housing, as shown in FIG. 41;

FIG. 44 shows a top view of the housing, as shown in FIG. 41; and

FIG. 45 shows a front view of a bolt and handle assembly, according to one embodiment of this invention.

### DETAILED DESCRIPTION OF THE INVENTION

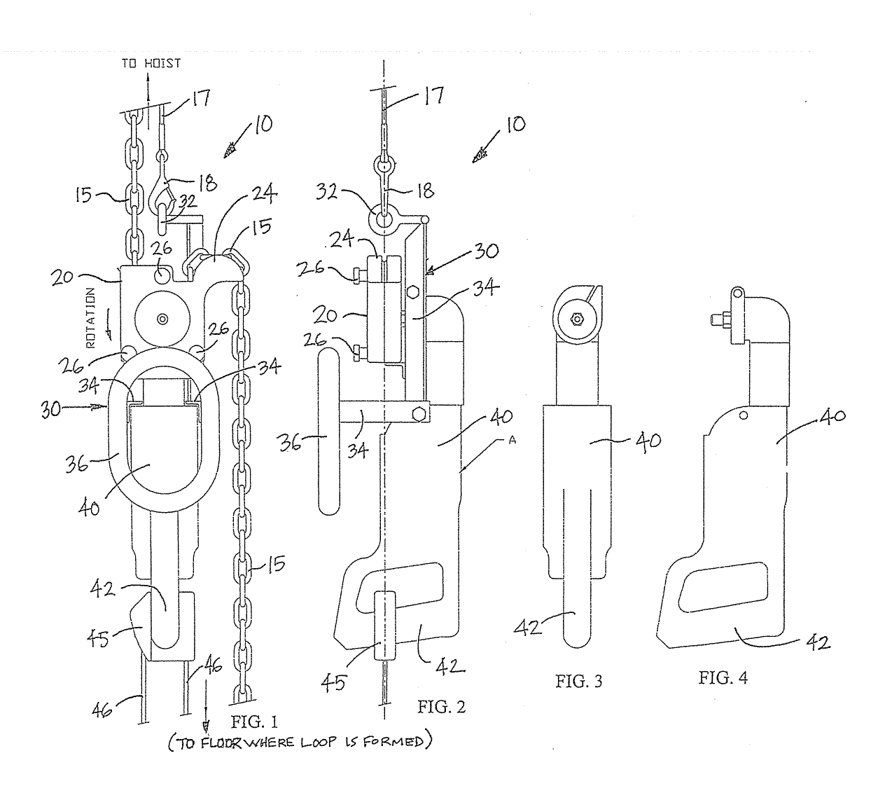

FIG. 1 shows a front view of chain hoist drive 10, with chain 15, according to one embodiment of this invention. For clarity purposes, FIG. 2 shows a side view of chain hoist drive 10 as shown in FIG. 1, but without chain 15. When used to lift a load, chain 15 enters, passes through and exits housing 20, such as shown in FIG. 1. In some embodiments of this invention, housing 20 comprises design features and/or elements that allow housing 20 to guard, guide, strip and return chain 15, such as shown in FIG. 1, as chain 15 enters, passes through and/or exits housing 20. In some embodiments of this invention, the guard prevents pinching of fingers, hands and the like, for example, between a moving hand chain 15 and sprocket 50. In some embodiments of this invention, the guide orientates the links of chain 15, for example, for proper entry into sprocket 50. The stripper feature helps or ensures that chain 15 exits or releases from sprocket 50. In some embodiments of this invention, the return reverses a direction of chain 15 moving toward a ground surface or a floor.

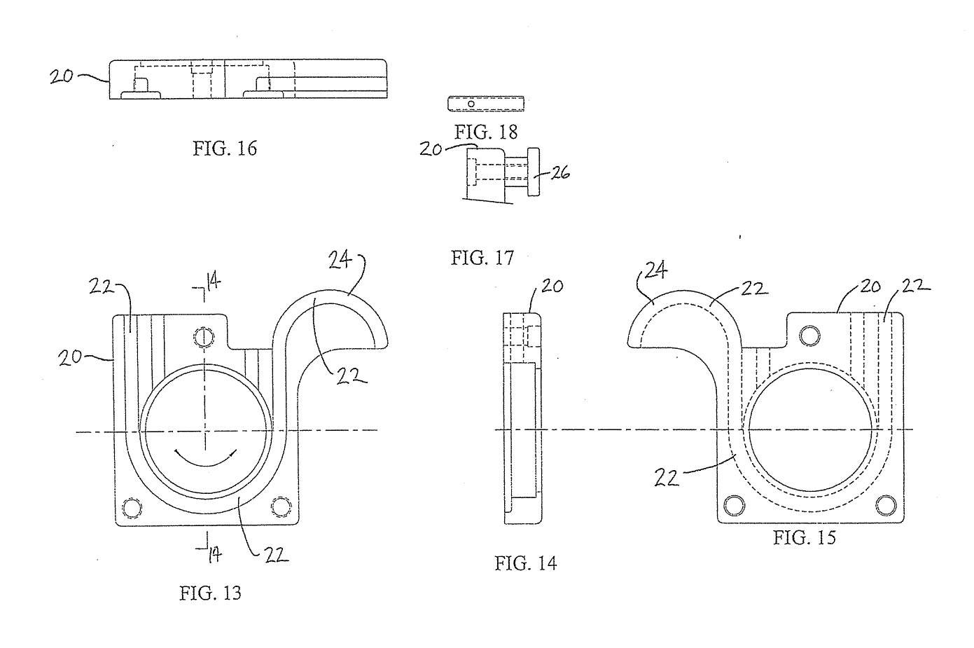

According to some embodiments of this invention, chain hoist drive 10 can be used to operate a hand chain, such as chain 15, of a hand chain hoist, such as a conventional hand chain hoist. In some embodiments of this invention, such as shown in FIGS. 13-16, housing 20 forms or has void 22 forming a pathway or a channel through which chain 15 can pass. Chain 15 can be movably mounted within void 22. In some embodiments of this invention, sprocket 50 is movably mounted within housing 20. For example, sprocket 50 can be mounted to move, rotate, pivot and/or otherwise move in any suitable fashion to engage with and accommodate chain 15, for example, so that chain 15 is movable within or through void 22 and engageable with sprocket 50.

FIGS. 1 and 2 show an upper portion of line 17 that is routed to and detachably connected or otherwise attached to an overhead structure and/or an overhead unit, such as a hoist or a trolley. In some embodiments of this invention, the opposite or lower end portion of line 17 is secured, connected and/or otherwise attached to a structure that connects directly or indirectly to or with support frame 30. As shown in FIGS. 1 and 2, line 17 is secured, connected and/or otherwise attached to hook 18 which can be detachably secured to support eye 32 of support frame 30. In other embodiments of this invention, hook 18 can comprise a snap or other safety feature and/or any other suitable fastener or connector that detachably connects support frame 30 with respect to line 17. As shown in FIGS. 1 and 2, line 17 comprises a cable but line 17 can comprise a chain and/or any other suitable structural element that connects support frame 30 with respect to the overhead structure or the overhead unit, such as the hoist or the trolley.

In some embodiments of this invention, line 17 comprises a structural element connecting housing 20 with respect to the overhead structure and/or any other suitable structure. The first structural element can be detachably connected to housing 20. In some embodiments of this invention, the first structural element is or comprises line 17 which is connected to the overhead structure and/or any other suitable structure.

FIGS. 1 and 2 show support frame 30 comprising support eye 32 that can be detachably connected and/or secured to line 17 and/or hook 18 or another suitable attachment device. Although it is possible to use the hand chain drive 10 without a secured or locked attachment between hook 18 and support eye 32, using the secured or locked attachment, such as with hook 18 having a spring-loaded snap feature or another suitable locking device, provides additional safety while operating chain hoist drive 10 according to this invention.

In some embodiments of this invention, the attachment device detachably connects line 17 or the corresponding structural element with respect to housing 20. FIG. 1 shows hook 18 having a locking device, for example, a spring-loaded device that can be used to releasably hold or lock line 17 or the corresponding structural element with respect to housing 20 and/or any other elements connected directly to or indirectly with respect to housing 20, such as support eye 32 shown in FIGS. 1, 2 and 5-7.

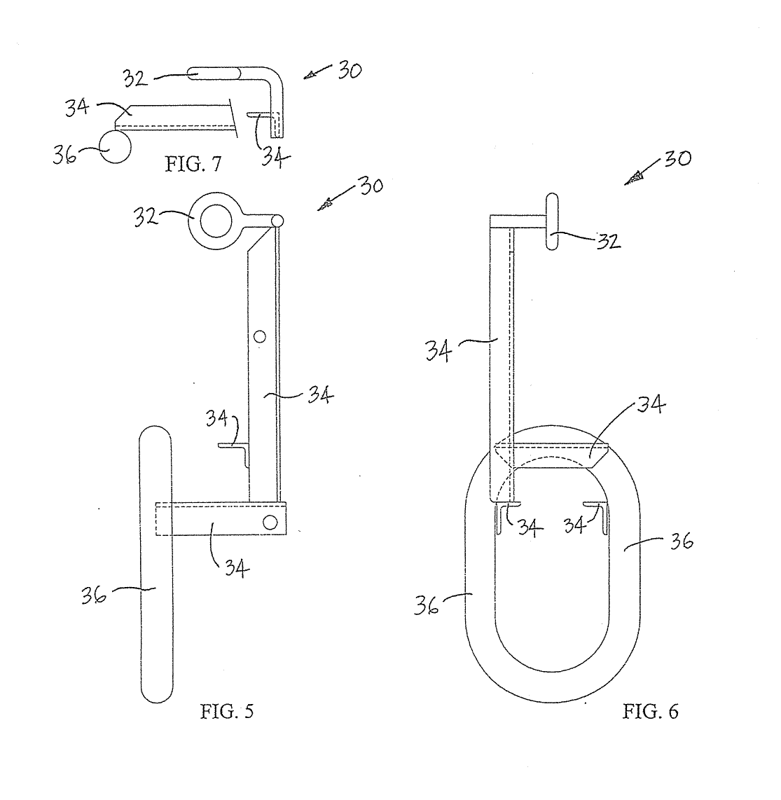

FIGS. 5-7 show different views of support frame 30 according to one embodiment of this invention, comprising support eye 32 welded or otherwise secured to one or more structural elements 34. FIGS. 5-7 also show structural ring 36 welded or otherwise secured to one or more structural elements 34. In other embodiments according to this invention, support frame 30 can be one integrated element and/or can have any other suitable structural shape and design that accommodates housing 20 and drive 40, such as a right angle drive which may or may not be a right angle drill. In some embodiments according to this invention, support frame 30 allows an operator to experience a lightened load during operation, for example, by the operator holding structural ring 36 and thus reducing or lessening the forces and/or loads the operator experiences, particularly when lifting a load at or near a maximum amount or weight.

FIGS. 3 and 4 show one embodiment of drive 40, which can be a conventional drill and/or drive. According to some embodiments of this invention, drive 40 can be any suitable conventional drill and/or drive, including but not limited to a right angle drill and/or drive. In some embodiments of this invention, drive 40 is operably connected to sprocket 50, for example, so that operating drive 40 rotates and/or otherwise moves sprocket 50. Operating or otherwise engaging or employing drive 40 can result in moving sprocket 50 which engages with and thus moves chain 15. In some embodiments of this invention, drive 40 moves sprocket 50 with respect to housing 20.

One embodiment of this invention, such as shown in FIGS. 3 and 4, includes drive 40 without a drill chuck or with the drill chuck removed. In some embodiments of this invention, drive 40 is a right angle drive or drill that engages with and moves sprocket 50 with respect to housing 20 and thus moves chain 15 with respect to sprocket 50 and/or housing 20. As shown in FIGS. 1-4, drive 40 has handle 42 which can be used by an operator to better hold chain hoist drive 10 according to this invention. Any other suitable conventional drill and/or drive can be used in place of drill 40 shown in FIGS. 1-4, but this may require modification to housing 20 and/or support frame 30, for example.

As shown in FIGS. 1, 2 and 24, lower anchor 45 is detachably secured with respect to line 46. In some embodiments of this invention, line 46 is a structural element holding housing 20 with respect to a fixed structural element, such as a structural support, a ground surface and/or any other suitable element that can fix and/or hold line 46 or another suitable structural element. In some embodiments of this invention, a length of line 46 can be varied and/or is adjustable, so that an operator can change a length of line 46 to snug up or tighten the linkage of line 16, housing 20 and line 17, for example, as chain 15 is routed through housing 20.

As shown in FIGS. 1 and 19-24, for example, anchor 45 can be operated and/or engaged to detachably secure housing 20 with respect to line 46 or the corresponding structural element. In some embodiments of this invention, anchor 45 adjustably secures line 46 or the corresponding structural element, for example, so that an operator can adjust the length of line 46 and lock or otherwise secure line 46 with enough force that the operator can use the operator's foot or another suitable fixed structure to hold line 46. In some embodiments of this invention, line 46 or the corresponding structural element releasably holds housing 20 with respect to a fixed structural element or the ground surface.

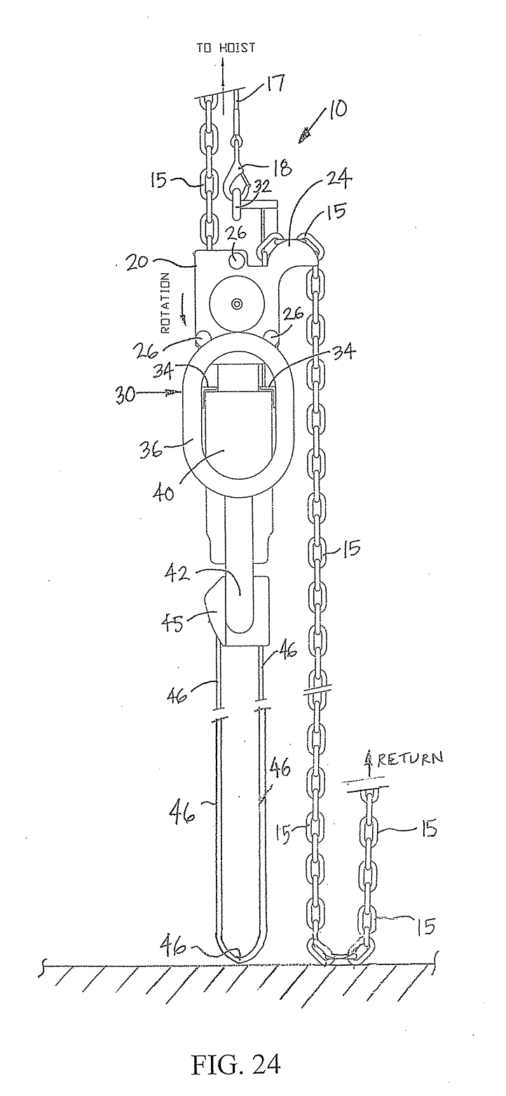

In some embodiments of this invention, line 46 can be adjusted in length, for example, by operating an adjustable securing device to change the length of line 46. In some embodiments of this invention, the operator forms a loop, for example, as shown in FIG. 24, with line 46 and then places the operator's foot on the loop portion of line 46 to hold and/or secure the loop formed by line 46. In other embodiments of this invention, line 46 can be secured and/or otherwise attached to a fixed structural element, such as to a fixed frame or to the ground, a ground surface and/or any suitable fixed structure, so that the operator does not have to use the operator's foot to secure chain hoist drive 10 during operation. However, using the operator's foot provides a faster and more convenient operation of chain hoist drive 10 according to this invention.

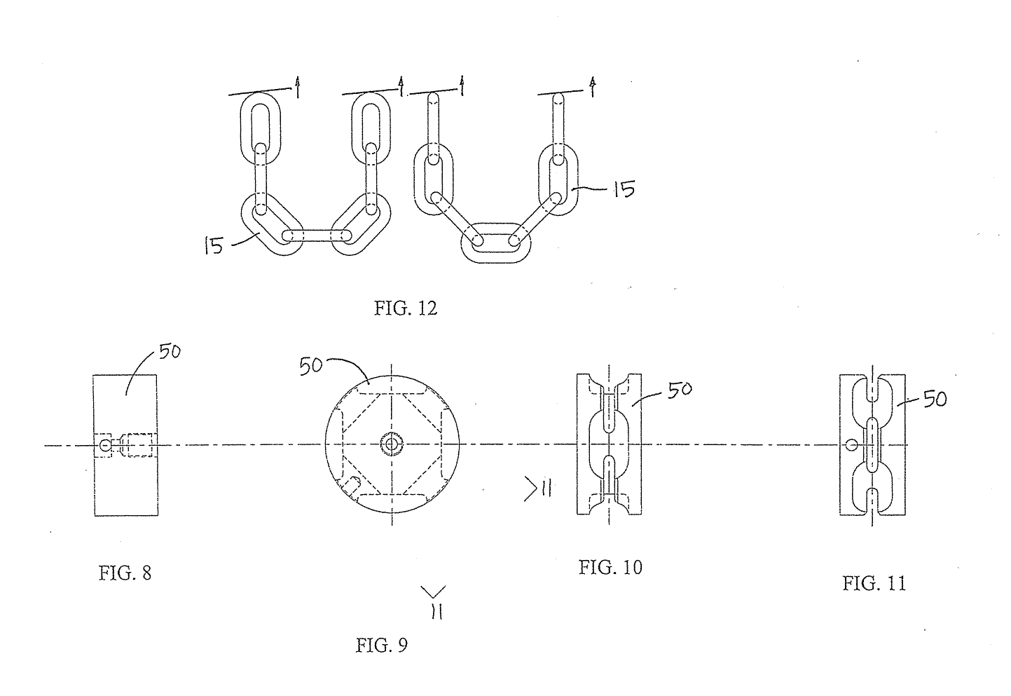

FIGS. 8-11 show different views of sprocket 50, according to one embodiment of this invention. The outer edges of sprocket 50 form the locating and bearing surface for a rotating sprocket 50. As shown in this embodiment of FIGS. 8-11, the features of sprocket 50 can be used with one particular type of chain. However, in other embodiments of this invention, sprocket 50 can have different shapes, design features and/or specifications, so that the same sprocket 50 can accommodate two or more types of chains 15, thus making sprocket 50 somewhat more universal between different manufacturers or providers of chains 15, and thus more capable of handling multiple types of chains 15, such as from different manufacturers, without changing to a different or another sprocket 50.

FIG. 12 shows chain 15 according to one embodiment of this invention. In other embodiments of this invention, chain 15 can have any other suitable features, shapes, dimensions and/or designs.

FIGS. 13-18 show different views of housing 20 comprising different elements and features that allow chain 15 to enter, pass through and exit housing 20 while still allowing chain 15 to be guarded, guided, stripped and returned as chain 15 moves with respect to housing 20. In some embodiments of this invention, housing 20 has one or more voids 22 that allow chain 15 to move with respect to housing 20. In some embodiments according to this invention, housing 20 has return section 24 that can guide chain 15 as it moves with respect to housing 20. Return section 24 can also be used to allow a long enough section of chain 15 to run or be suspended from housing 20 to above the ground or other floor surface, which can keep tension and/or another suitable force on chain 15 so that chain 15 can be exited or discharged from housing 20 without chain 15 binding or stopping with respect to housing 20. In some embodiments of this invention, fasteners 26 can be used to detachably secure a suitable cover with respect to housing 20, so that, for example, a different sprocket 50 can be installed or inserted within a corresponding space or void formed by housing 20.

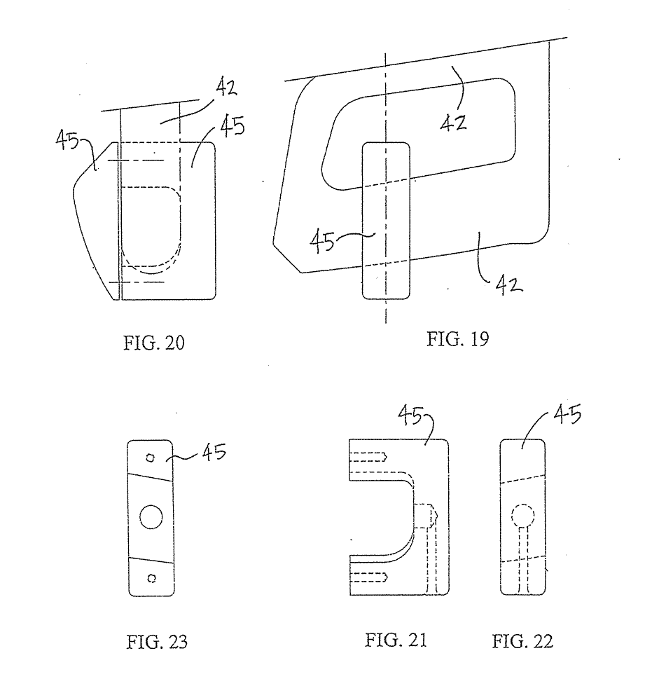

FIGS. 19-23 show different views of lower anchor 45, according to different embodiments of this invention. FIGS. 19 and 20 show one embodiment of lower anchor 45 mounted with respect to handle 42 of right angle drive 40. Lower anchor 45 and drive 40 can have any other suitable shapes and/or dimensions and still allow lower anchor 45 to be detachably secured with respect to drive 40. FIGS. 21-23 show one embodiment of design features of lower anchor 45.

In some embodiments according to this invention, the method of using hand chain drive 10 includes installing and/or securing line 17 to an overhead structure, such as a hoist or a trolley, and attaching hook 18 of line 17 with respect to support frame 30, such as by using support eye 32, resulting in supporting hand chain drive 10 at a level that an operator can use or operate chain hoist drive 10. A cover can be removed from housing 20 and a suitable sprocket 50 can be installed within a space or void formed by housing 20. The cover can be attached to cover and/or retain sprocket 50 within housing 20. When lifting a load with chain hoist drive 10 of this invention, the operator can place the operator's foot on and hold line 46 and then lift the work load by operating drive 40. To then lower the work load, the operator can open the cover, remove the lifting section of the chain and replace it with the lowering section of the chain, replace the cover, and again operate drive 40 to move the load in the opposite direction.

According to some embodiments of this invention, a method for operating chain hoist drive 10, for example, to move chain 15 of a hand chain hoist, includes securing line 17 or the corresponding structural element to the overhead structure. Line 17 or the corresponding structural element is detachably connected to housing 20. Drive 40 can be operated to move chain 15 through housing 20, either in a lifting direction or a lowering direction. Line 46 can be adjusted in length, for example, to hold or secure housing 20 with respect to the fixed structural element or the ground surface.

In some embodiments of this invention, anchor 45 adjustably secures line 46 or the corresponding structural element with respect to housing 20. Line 46 or the corresponding structural element can be used to releasably hold housing 20 with respect to the fixed structural element or the ground surface. In some embodiments of this invention, moving chain 15 through housing 20 includes or comprises moving through housing 20 either a lifting section of chain 15 or a lowering section of chain 15. In some embodiments of this invention, the lifting section and the lowering section are interchangeable with each other, so that an operator can use chain hoist drive 10 of this invention with the lifting section of chain 15 to lift a load by operating a hand chain hoist and then switch out or change the lifting section to the lowering section of chain 15 to lower the load by operating the hand chain hoist.

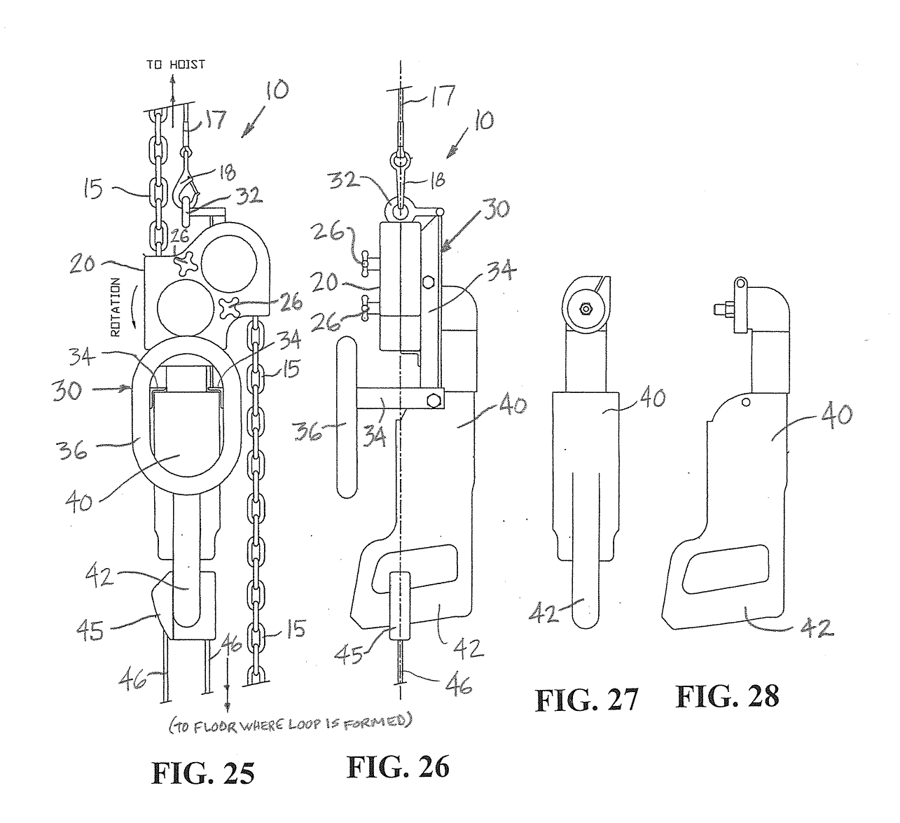

FIG. 25 shows a front view of chain hoist drive 10, with chain 15, according to another embodiment of this invention. For clarity purposes, FIG. 26 shows a side view of chain hoist drive 10 as shown in FIG. 25, but without chain 15. Similar to the embodiment as shown in FIGS. 1-4, when used to lift a load, chain 15 enters, passes through and exits housing 20, such as shown in FIG. 25. Also similar to the embodiment as shown in FIGS. 1-4, housing 20 has design features and/or elements that allow housing 20 to guard, guide, strip and return chain 15, such as shown in FIG. 25, as chain 15 enters, passes through and/or exits housing 20. In some embodiments of this invention, the guard prevents pinching of fingers, hands and the like, for example, between a moving hand chain 15 and each pulley 60. In some embodiments of this invention, the guide orientates the links of chain 15, for example, for proper entry into each pulley 60. The two circles shown on housing 20 in FIG. 25 schematically shows that some embodiments of chain hoist drive 10 has two pulleys 60 that cooperate with each other and thus each engage with chain 15. The stripper feature helps or ensures that chain 15 exits or releases from pulley 60. In some embodiments of this invention, the return reverses a direction of chain 15 moving toward a ground surface or a floor.

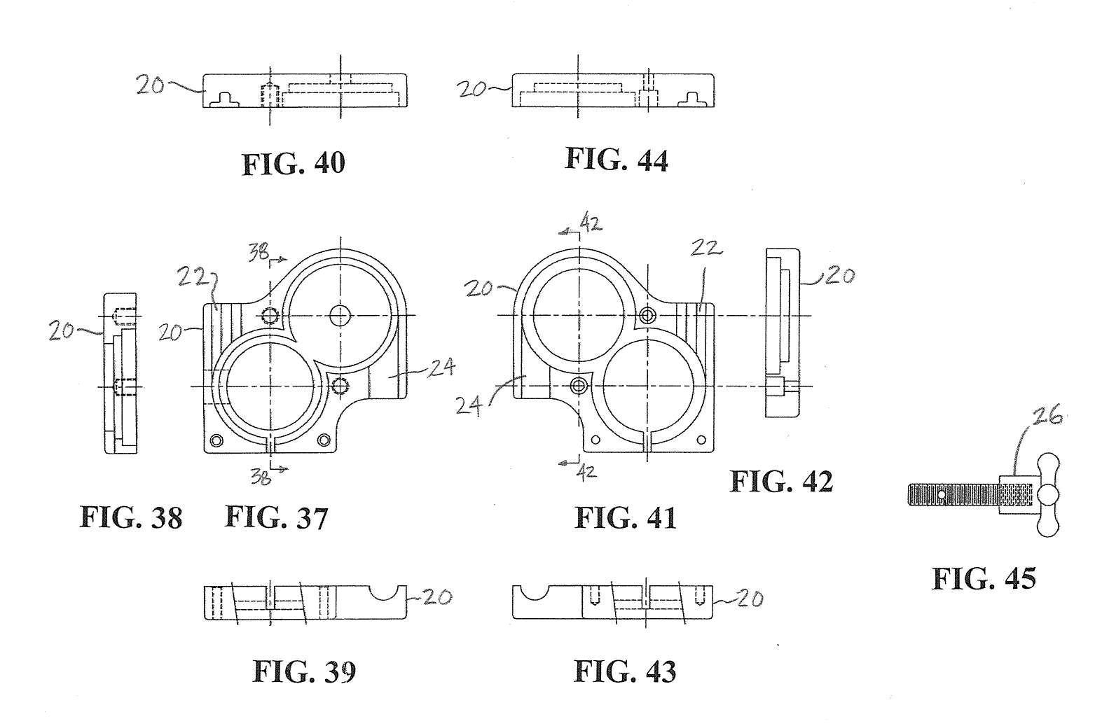

FIGS. 37-44 show some embodiments of this invention in which housing 20 forms or has void 22 forming a pathway or a channel through which chain 15 can pass. Chain 15 can be movably mounted within void 22. In some embodiments of this invention, two or more pulleys 60 cooperate with chain 15 and with each other to move chain 15 through housing 20. In some embodiments of this invention, pulleys 60 are identical to each other and in other embodiments of this invention pulleys 60 differ from each other. Each pulley 60 is movably mounted within housing 20. For example, each pulley 60 can be mounted to move, rotate, pivot and/or otherwise move in any suitable fashion to engage with and accommodate chain 15, for example, so that chain 15 is movable within or through void 22 and engageable with each pulley 60.

FIGS. 25 and 26 show an upper portion of line 17 that is routed to and detachably connected or otherwise attached to an overhead structure and/or an overhead unit, such as a hoist or a trolley. In some embodiments of this invention, the opposite or lower end portion of line 17 is secured, connected and/or otherwise attached to a structure that connects directly or indirectly to or with support frame 30. As shown in FIGS. 25 and 26, line 17 is secured, connected and/or otherwise attached to hook 18 which can be detachably secured to support eye 32 of support frame 30. In other embodiments of this invention, hook 18 can comprise a snap or other safety feature and/or any other suitable fastener or connector that detachably connects support frame 30 with respect to line 17. As shown in FIGS. 25 and 26, line 17 comprises a cable but line 17 can comprise a chain and/or any other suitable structural element that connects support frame 30 with respect to the overhead structure or the overhead unit, such as the hoist or the trolley.

In some embodiments of this invention, line 17 comprises a structural element connecting housing 20 with respect to the overhead structure and/or any other suitable structure. The first structural element can be detachably connected to housing 20. In some embodiments of this invention, the first structural element is or comprises line 17 which is connected to the overhead structure and/or any other suitable structure.

FIGS. 25 and 26 show support frame 30 comprising support eye 32 that can be detachably connected and/or secured to line 17 and/or hook 18 or another suitable attachment device. Although it is possible to use hand chain drive 10 without a secured or locked attachment between hook 18 and support eye 32, using the secured or locked attachment, such as with hook 18 having a spring-loaded snap feature or another suitable locking device, provides additional safety while operating chain hoist drive 10 according to this invention.

In some embodiments of this invention, the attachment device detachably connects line 17 or the corresponding structural element with respect to housing 20. FIG. 25 shows hook 18 having a locking device, for example, a spring-loaded device that can be used to releasably hold or lock line 17 or the corresponding structural element with respect to housing 20 and/or any other elements connected directly to or indirectly with respect to housing 20, such as support eye 32 shown in FIGS. 25, 26 and 5-7.

FIGS. 27 and 28 show one embodiment of drive 40, which can be a conventional drill and/or drive. According to some embodiments of this invention, drive 40 can be any suitable conventional drill and/or drive, including but not limited to a right angle drill and/or drive. In some embodiments of this invention, drive 40 is operably connected to each pulley 60, for example, so that operating drive 40 rotates and/or otherwise moves at least one driven pulley 60. Operating or otherwise engaging or employing drive 40 can result in moving one pulley 60 which then moves all remaining pulleys 60 which engage with and thus moves chain 15. In some embodiments of this invention, drive 40 moves one pulley 60 which then moves each remaining pulley 60 with respect to housing 20.

In some embodiments according to this invention, gear 74 is a spur gear. In other embodiments of this invention, gear 74 can be any other suitable type of gear. As shown in FIG. 34, the peripheral phantom line represents gear teeth. In some embodiments of this invention, drive 40 engages with the gear teeth to move gear 74. According to some embodiments of this invention, the driven gear 74 can engage with and drive or move another gear 74 of a different pulley 60 mounted within housing 20. In some embodiments of this invention, all pulleys 60 can be driven or moved by moving or driving one pulley 60.

One embodiment of this invention, such as shown in FIGS. 27 and 28, includes drive 40 without a drill chuck or with the drill chuck removed. In some embodiments of this invention, drive 40 is a right angle drive or drill that engages with and moves one pulley 60 with respect to housing 20 and thus moves each remaining pulley 60 and thus chain 15 with respect to each pulley 60 and/or housing 20. As shown in FIGS. 25-28, drive 40 has handle 42 which can be used by an operator to better hold chain hoist drive 10 according to this invention. Any other suitable conventional drill and/or drive can be used in place of drill 40 shown in FIGS. 25-28, but this may require modification to housing 20 and/or support frame 30, for example.

As shown in FIGS. 24-26, lower anchor 45 is detachably secured with respect to line 46. In some embodiments of this invention, line 46 is a structural element holding housing 20 with respect to a fixed structural element, such as a structural support, a ground surface and/or any other suitable element that can fix and/or hold line 46 or another suitable structural element. In some embodiments of this invention, a length of line 46 can be varied and/or is adjustable, so that an operator can change a length of line 46 to snug up or tighten the linkage of line 16, housing 20 and line 17, for example, as chain 15 is routed through housing 20.

As shown in FIGS. 25 and 19-24, for example, anchor 45 can be operated and/or engaged to detachably secure housing 20 with respect to line 46 or the corresponding structural element. In some embodiments of this invention, anchor 45 adjustably secures line 46 or the corresponding structural element, for example, so that an operator can adjust the length of line 46 and lock or otherwise secure line 46 with enough force that the operator can use the operator's foot or another suitable fixed structure to hold line 46. In some embodiments of this invention, line 46 or the corresponding structural element releasably holds housing 20 with respect to a fixed structural element or the ground surface.

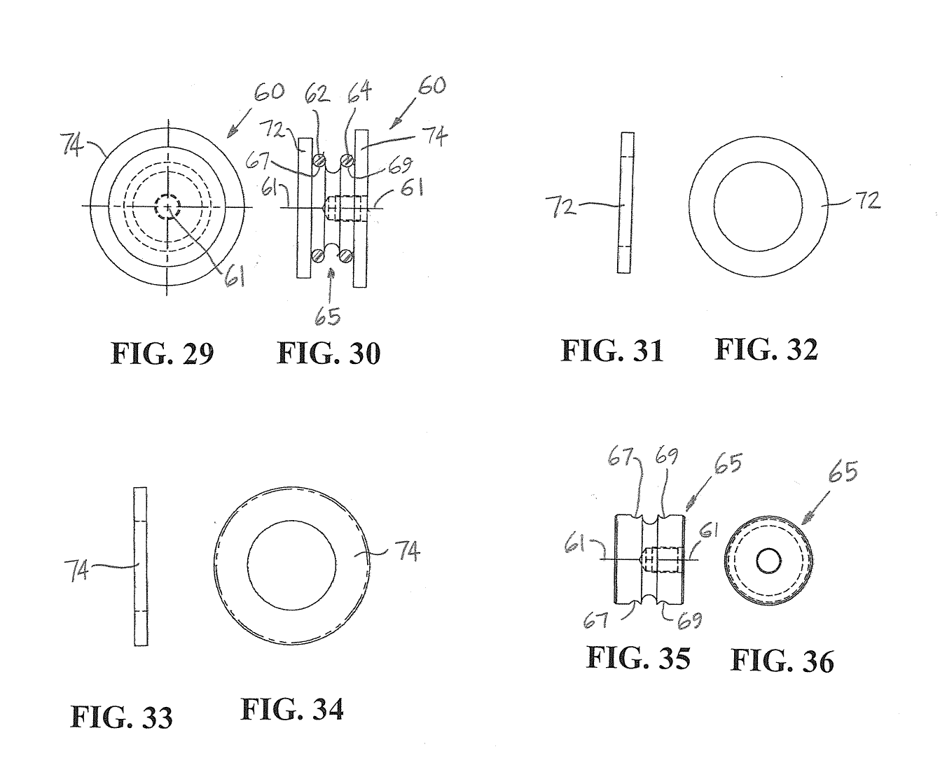

FIGS. 29-36 show different views of pulley 60, according to one embodiment of this invention. In some embodiments according to this invention, sprocket 50 can be replaced by two pulleys 60 which can result in a smoother and quieter operating chain hoist drive 10 according to this invention. In some embodiments of this invention, it is possible to replace the function of the outer edges of sprocket 50 that form the locating and bearing surface for a rotating sprocket 50 with the function of the outer portions of pulley 60 that form the locating and bearing surface for each rotating pulley 60. As shown in this embodiment of FIGS. 8-11, the features of sprocket 50 can be used with one particular type of chain, and in some applications that use a differently sized chain it is necessary to change sprocket 50 to a different size sprocket 50, which can be time-consuming from a labor standpoint. However, in some embodiments of this invention, each pulley 60 can have different shapes, design features and/or specifications, so that the same pulley 60 can accommodate two or more types of chains 15, thus making pulleys 60 somewhat more universal between different manufacturers or providers of chains 15, and thus more capable of handling multiple types of chains 15, such as from different manufacturers, without the need to change to a different or another type or size of pulley 60.

In some embodiments according to this invention, such as shown in FIGS. 29-36, each pulley 60 comprises O-ring 62 and O-ring 64 each replaceably mounted on or with respect to hub 65, respectively, in any suitable mechanical and/or other structural manner. According to some embodiments of this invention, as shown in FIGS. 30 and 35, hub 65 has circumferential groove 67 and circumferential groove 69 accommodating a mounting of O-ring 62 and O-ring 64, respectively. Chain 15 engages with O-rings 62 and 64 and makes contact with O-rings 62 and 64 as chain 15 moves through housing 20. O-ring 62 and/or O-ring 64 can be sized the same or can be sized differently, depending upon the type and size of chain 15.

In some embodiments of this invention, having O-ring 62 and/or O-ring 64 replaceable allows for quick and easy or simple replacement of a spent or worn O-ring 62 and/or O-ring 64. The use of O-rings as part of pulley 60 allows for a relatively inexpensive replacement part and a relatively inexpensive overall manufacturing cost for each pulley 60, particularly when compared to the overall and operating costs of sprocket 50, for example. Because each pulley 60 with O-rings 62 and 64 can accommodate many different sizes of chain 15, there is no need to change pulleys 60 when using a different size or type of chain 15, which also significantly reduces the labor time needed to otherwise change sprocket 50, for example, for differently sized indoor types of chain 15.

FIGS. 29 and 30 show one embodiment of pulley 60, according to this invention. As shown in FIG. 30, pulley 60 comprises hub 65 shaped or formed so that when mounted O-ring 62 and O-ring 64 are positioned generally parallel with respect to each other and in other embodiments O-ring 62 and O-ring 64 are positioned in a nonparallel manner with respect to each other. In some embodiments of this invention, hub 65 or any other suitable element has circumferential groove 67 and/or circumferential groove 69. FIG. 30 shows O-ring 62 mounted within circumferential groove 67 and O-ring 64 mounted within circumferential groove 69. Hub 65 can have any other structural feature and/or element that allows O-rings 62 and 64 to be detachably mounted or replaceable from or with respect to hub 65. Any other suitable structural element and/or system can be used to mount, secure and/or retain O-ring 62 and/or O-ring 64 in a mounted and replaceable position with respect to elements other than hub 65. O-ring 62 and/or O-ring 64 can have any suitable overall shape and can have a generally circular cross sectional shape, such as shown in FIG. 30, or can have any other suitable cross sectional shape. In some embodiments according to this invention, such as shown in FIG. 30, hub 65 is rotatably mounted about longitudinal axis 61 of pulley 60.

According to some embodiments of this invention, disc 72 is mounted on an outside surface of hub 65 and/or gear 74 is mounted on an outside surface of hub 65. Disc 72 and/or gear 74 can have a suitable size, material selection, design and/or shape that guards or retains chain 15 as chain 15 moves through each pulley 60 and particularly as chain 15 engages with O-rings 62 and 64. Disc 72 and/or gear 74 can be sized differently, such as shown in FIG. 30, or can be sized similar or the same depending upon the intended use and size or type of chain 15. As shown in FIGS. 30, 32 and 34, a diameter of disc 72 is differently sized compared to a diameter of gear 74, but in other embodiments of this invention disc 72 and gear 74 can be sized the same or similarly.

In some embodiments according to this invention, at least a portion of pulley 60 can be formed by hub 65 which can include, can be formed by or can comprise disc 72, retainer 74 and/or any other structure or element suitable for mounting O-ring 62 and/or O-ring 64. In some embodiments of this invention, hub 65 is one integral piece and in other embodiments of this invention, hub 65 is formed by 2 or more attached or connected pieces. Hub 65 can have any suitable shape, size and/or material, depending upon the intended use of each pulley 60.

FIGS. 37-44 show different views of housing 20 comprising different elements and features that allow chain 15 to enter, pass through and exit housing 20 while still allowing chain 15 to be guarded, guided, stripped and returned as chain 15 moves with respect to housing 20. In some embodiments of this invention, housing 20 has one or more voids 22 that allow chain 15 to move with respect to housing 20. In some embodiments according to this invention, housing 20 has return section 24 that can guide chain 15 as it moves with respect to housing 20. Return section 24 can also be used to allow a long enough section of chain 15 to run or be suspended from housing 20 to above the ground or other floor surface, which can keep tension and/or another suitable force on chain 15 so that chain 15 can be exited or discharged from housing 20 without chain 15 binding or stopping with respect to housing 20. In some embodiments of this invention, fasteners 26, such as shown in FIG. 18 and/or FIG. 45, can be used to detachably secure a suitable cover with respect to housing 20, so that, for example, a different pulley 60 can be installed or inserted within a corresponding space or void formed by housing 20.

In some embodiments according to this invention, the method of using hand chain drive 10 includes installing and/or securing line 17 to an overhead structure, such as a hoist or a trolley, arid attaching hook 18 of line 17 with respect to support frame 30, such as by using support eye 32, resulting in supporting hand chain drive 10 at a level that an operator can use or operate chain hoist drive 10. A cover can be removed from housing 20 and preferably two but at least one suitable pulley 60 can be installed within a space or void formed by housing 20. The cover can be attached to cover and/or retain each pulley 60 within housing 20. When lifting a load with chain hoist drive 10 of this invention, the operator can place the operator's foot on and hold line 46 and then lift the work load by operating drive 40. To then lower the work load, the operator can open the cover, remove the lifting section of the chain and replace it with the lowering section of the chain, replace the cover, and again operate drive 40 to move the load in the opposite direction. In some embodiments of this invention using pulleys 60, it is not necessary to change out, replace or modify each pulley 60 to accommodate differently sized chains 15.

While in the foregoing specification this invention has been described in relation to certain preferred embodiments, and many details are set forth for purposes of illustration, it will be apparent to those skilled in the art that this invention is susceptible to additional embodiments and that certain of the details described in this specification and in the claims can be varied considerably without departing from the basic principles of this invention.

What is claimed is:

1. An apparatus for operating a hand chain of a hand chain hoist, the apparatus comprising:
a housing having a housing void, the hand chain movably mounted within the housing void, a plurality of pulleys movably mounted within the housing, the hand chain movable within the housing void and engageable with the pulleys, a drive operably connected to a first pulley of the pulleys, a first structural element connecting the housing to an overhead structure, and a second structural element holding the housing with respect to a fixed structural element.

2. The apparatus according to claim 1 wherein the drive moves the first pulley with respect to the housing.

3. The apparatus according to claim 1 wherein the drive is a right angle drill engaging and moving the first pulley with respect to the housing.

4. The apparatus according to claim 1 wherein each of the pulleys has a first O-ring and a second O-ring each engageable with the hand chain.

5. The apparatus according to claim 4 wherein the first O-ring is generally parallel to the second O-ring.

6. The apparatus according to claim 4 further comprising a hub, the first O-ring mounted on the hub and the second O-ring mounted on the hub.

7. The apparatus according to claim 6 wherein the hub has a first circumferential groove accommodating the first O-ring and the hub has a second circumferential groove accommodating the second O-ring.

8. The apparatus according to claim 6 wherein the hub is rotatably mounted about a longitudinal axis of the pulley.

9. The apparatus according to claim 6 wherein a disc is mounted on a first outside surface of the hub and a gear is mounted on a second outside surface of the hub.

10. The apparatus according to claim 9 wherein the gear has a first diameter greater than a second diameter of the disc.

11. The apparatus according to claim 9 wherein gear is a spur gear.

12. The apparatus according to claim 6 wherein the first O-ring and second O-ring each is releasably mounted with respect to the hub.

13. The apparatus according to claim 9 wherein the gear has peripheral teeth engaging with the drive.

14. An apparatus for operating a hand chain of a hand chain hoist, the apparatus comprising:
a housing having a housing void, the hand chain movable within the housing void, a plurality of pulleys movably mounted within the housing, the pulleys engaging the hand chain in the housing void, and a drive operating one of the pulleys.

15. The apparatus according to claim 14 wherein the pulley comprises a hub forming a first circumferential groove accommodating a first O-ring and a second circumferential groove accommodating a second O-ring.

16. The apparatus according to claim 15 wherein a disc is mounted on a first outside surface of the hub and a gear is mounted on a second outside surface of the hub.

17. A method for operating a chain hoist drive to move a hand chain of a hand chain hoist, the method including the steps of:
securing a first structural element to an overhead structure;
detachably connecting the first structural element to a housing;
operating pulleys to move the hand chain through the housing; and
holding a second structural element to secure the housing with respect to a fixed structural element or a ground surface.

18. The method according to claim 17 wherein the pulley comprises a hub forming a first circumferential groove accommodating a first O-ring and a second circumferential groove accommodating a second O-ring.

19. The method according to claim 18 wherein a disc mounted on a first outside surface of the hub and a gear mounted on a second outside surface of the hub retain the hand chain moving within a void of the housing.

20. The method according to claim 17 wherein moving the hand chain through the housing includes moving through the housing a lifting section of the hand chain or a lowering section of the hand chain, and the lifting section and the lowering section are interchangeable with each other.
